(19) United States
(12) Patent Application Publication
(10) Pub. No.: US 2023/0243240 A1
(43) Pub. Date: Aug. 3, 2023

(54) STORING SOLID CARBON-BEARING PARTICLES IN GEOLOGIC FORMATIONS

(71) Applicants: Lawrence Corlies Murdoch, Anderson, SC (US); Leonid Nisson Germanovich, Villanova, PA (US); William W. Slack, Cincinnati, OH (US)

(72) Inventors: Lawrence Corlies Murdoch, Anderson, SC (US); Leonid Nisson Germanovich, Villanova, PA (US); William W. Slack, Cincinnati, OH (US)

(21) Appl. No.: 17/590,351

(22) Filed: Feb. 1, 2022

(51) Int. Cl. E21B 41/00

(52) U.S. Cl. CPC E21B 41/0064; G06N 20/00

(57) ABSTRACT

Carbon-bearing solid particles are stored in geologic formations to isolate carbon from the atmosphere, thereby reducing the atmospheric CO2 concentration. The carbon is in a solid compound, such as wood chips, crop waste, plastic, algae, biochar, which is processed into small particles. Solid particles are mixed with fluid to create a slurry and inject it into the subsurface at a shallow depth. This will create a hydraulic fracture that is filled with the solid particles. Carbon in a solid phase is immobile in the fracture, so it can be stored at shallower depths in a wider range of geologic settings, and with less stringent monitoring compared to storing CO2 in deep formations. Some fractures may be steeply dipping, growing upward, reaching the ground, and comprising storage. This issue is addressed by creating multiple, small hydraulic fractures until the stresses change, so that new fractures are about horizontal.

### BACKGROUND OF THE INVENTION

It is widely recognized that there is an urgent need to reduce the concentration of carbon dioxide in the atmosphere. This requires large scale reductions in the rate at which carbon dioxide is emitted to the atmosphere by humans. This also requires technologies that are capable of removing carbon dioxide that was emitted in the past. This so-called negative emission, or carbon removal, technologies generally include two main steps, one where the carbon dioxide is removed from the atmosphere and another where it is stored in such a way to prevent it from returning back to the atmosphere for an extended period.

Negative Emission Technologies.

Negative emission technologies are recognized to range from natural methods to technological methods of removing carbon dioxide. The natural methods include increasing the mass of growing plants, such as by planting more trees or stimulating the growth of phytoplankton, or by managing land use to affect the carbon cycle in soils. Those technologies share a common trait of using biological reactions, typically photosynthesis, to remove carbon dioxide from the atmosphere. Another natural negative emission technology includes combining CO2 with rocks containing the mineral olivine to cause a chemical reaction that creates calcite, which stores carbon in a stable crystal structure. The natural methods of carbon dioxide separation have the common trait of creating a reaction that converts gaseous carbon dioxide to solid phase.

Technological methods use industrial processes to separate carbon dioxide from other gases. A common approach is for these methods to pass the gas through a solvent that selectively removes the carbon dioxide in a first step, and then the carbon dioxide is removed from the solvent in a second step. The solvent is then reused. One promising application for separating carbon dioxide is from the gases produced by combustion of fuels, in which the concentration of carbon dioxide is relatively high. Another interesting application is capturing carbon dioxide directly from the air, which is challenged by the low concentration of carbon dioxide in air compared to combustion products.

Storing or sequestering carbon is an important aspect because it ensures that the carbon removal process has a lasting effect on concentrations of carbon dioxide in the atmosphere. The current view is that carbon must be stored for at least 100 years, but 1000 years or longer would have an even better impact on reducing carbon dioxide concentrations. The low cost of separating carbon dioxide into biomass using photosynthesis makes natural methods attractive, but the ability to store or sequester carbon in biomass under aerobic conditions can be limited and this calls into question the ability of many natural methods of carbon removal to store carbon for at least 100 years or longer.

The carbon stored in a tree is released to the atmosphere within a few years after the tree dies as a result of oxidization reactions caused by microbes and fungi, for example. One concept to reduce the rate of degradation of wood and therefore extend the duration of carbon storage is to bury logs in deep trenches dug into the subsurface because the burial process will reduce the oxygen available to microbes and fungi. Another method of extending the durability of carbon removal is to put the carbon into a commercial product that will be isolated from degradation reactions. This includes creating wood products, such as furniture, that are treated with a preservative. The process of reacting carbon dioxide to create calcite is attractive because the rate of degradation of calcite is slower than biomass.

The lasting effect of geologic storage is currently unavailable to protect the release of carbon from biomass, although a related process has been proposed. Zeng and et al. (2014) have suggested that logs be buried in deep trenches to reduce the rate of degradation and promote the duration of carbon storage. Importantly, Zeng and coworkers analyzed the rate at which wood could be harvested on a sustainable basis that would have limited detrimental effects on the environment. They concluded that biomass would be available at a sustainable rate of about 1 Gigaton of carbon dioxide equivalent. This represents an important fraction of the rate at which carbon must be stored to prevent catastrophic increases in the global temperature. Unfortunately, however, the process of burying wood in trenches would require significant effort and would result in limited additional value beyond storing carbon. As a result of these and possibly other factors, the process of storing wood in trenches is not recognized as a viable method.

Geologic Carbon Storage.

Storing carbon in geologic formations is the only viable approach for storing CO2 in large quantities. The approach is to separate CO2 from other gases and inject it into a well that extends to a geologic formation with particular characteristics. One characteristic is that the formation must be capable of trapping and preventing the upward flow caused by the buoyancy of CO2. Ensuring the ability to trap CO2 in the subsurface currently requires significant effort to thoroughly characterize the trapping ability of a geologic formation before it is used for storage, and it also requires detailed monitoring to ensure the CO2 remains trapped and does not leak out of the formation. Another important characteristic of geologic storage of CO2 is that the geologic formation should be deeper than about one kilometer in order to ensure the hydrostatic pressure is sufficient to compress the CO2 into a supercritical state. Depleted reservoirs of natural gas and deep saline aquifers are viewed as possible candidates for geologic storage of CO2.

Establishing the ability to trap buoyant CO2 and then monitoring to ensure that the CO2 remains trapped mean that only a limited number of geologic formations are suitable for geologic storage, and the costs of monitoring can be significant. Nevertheless, despite these constraints geologic storage is currently regarded as the best method of storing carbon because it has the potential to isolate carbon from the atmosphere for far longer than carbon stored in the near-surface terrestrial environment. This view is manifested in the current regulations of the 45Q tax credit for carbon storage, which provides $50/ton of CO2 in geologic storage compared to $20/ton of CO2 stored in shallow terrestrial settings. CO2 in gaseous or supercritical form is currently the only form of carbon that is recognized as suitable for geologic storage because current methods assume the carbon is injected into the small pore of geologic formations.

Injecting Solid Particles.

Injecting solid compounds in the subsurface is possible, but in most locations it requires that injection pressures are large enough to deform the pores in the a geologic formation. The deformation consists of dilation of the pores until grains in the formation separate and a roughly planar cavity is created. The opening of the cavity can be many times greater than the original size of the pores and this allows solid particles to be mixed with a fluid and injected as a slurry to fill the cavity. The walls of the cavity close after injection and stresses from the geological formation are transferred to the injected solid particles, holding them in place. This results in a lens of solid particles in a subsurface formation.

Creating roughly planar cavities by injecting a fluid into a porous medium and then filling the cavity with solid particles will be recognized as the process of hydraulic fracturing by people working in the field of petroleum engineering where the technique is widely used to stimulate the production of hydrocarbons from wells. In this case, particles of sand are injected to create a permeable layer that facilitates the drainage of hydrocarbons from reservoir rocks, which are typically at depths of many thousands of feet.

Hydraulic fracturing is also used for to stimulate well production at much shallower depths, and it is used as a method by the environmental industry to deliver reactive compounds to clean up contaminated aquifers. A wide range of materials, including metallic iron and oxidizing chemicals in particulate form have been injected into hydraulic fractures to clean up contaminants. The material injected in most deep applications is sand, but some applications have used crushed walnut shells or other biomass.

Injection to Create Vertical Displacement.

When hydraulic fractures open, they cause displacement in the neighboring geologic materials, and these displacements are sometimes measured and interpreted to estimate the geometry of an underlying hydraulic fracture. Electrical sensors, like tiltmeters, are used to monitor tilting of the ground surface, and leveling techniques are used to measure the vertical displacement. Seismic and other geophysical techniques also can be used to acquire data that can support assessment of the underlying fracture.

The ability of a hydraulic fracture to cause vertical displacement at the ground surface is used by the geotechnical industry to compensate for localized subsidence that may affect built structures. Usually cement grout is injected into hydraulic fractures in this application. Compensation grouting was used under the Big Ben clock tower in London to offset the subsidence caused when a tunnel was bored beneath the foundation of the building, as an example. Compensation grouting is typically used to fix local problems with subsidence at scales smaller than about 1 hectare. This technique was demonstrated at a site in Proveglia, Italy, and in Florida (Germanovich and Murdoch, 2010).

The process of injecting solid compounds to raise the ground surface was described by Germanovich and Murdoch (Germanovich, L. N. and Murdoch, L. C., 2010, Injection of solids to lift coastal areas, Vol 466, Issue 2123, Proc. R. Soc. A, https:/doi.org/10.1098/rspa.2010.0033). They presented the concept of injecting solid compounds into borings to create permanent upward displacements for the purpose of reducing the risk of flooding. They termed this process Solid Injection to Raise Ground Elevation (SIRGE).

The SIRGE method is based on injecting solid particles to increase the average upward displacement of the ground surface to reduce the depth of water that accumulates as a result of inundation episodes including episodic tidal flooding, storm surge, flooding from extreme rainfall, lowering the ground surface by subsidence, and other flooding events apparent to those skilled in the art. SIRGE injects solid particles to raise the ground surface elevation over a large area (say, an acre or a hectare or larger), it can be combined with known methods of displacing the ground surface over smaller areas, including compensation grouting.

Injecting Biomass.

Biomass has been injected to prop open hydraulic fractures for many years, with early practitioners using crushed walnut shells because of their high strength and low cost. Burts (Burts B. D., 1997, U.S. Pat. No. 6,016,871, Hydraulic fracturing additive, hydraulic fracturing treatment fluid made therefrom, and method of hydraulically fracturing a subterranean formation) identifies as suitable proppants a long list of materials including “comminuted plant materials of nut and seed shells or hulls of almond, brazil, cocoa bean, coconut, cotton, flax, grass, linseed, maize, millet, oat, peach, peanut, rice, rye, soybean, sunflower, walnut, and wheat; rice tips; rice straw; rice bran; crude pectate pulp; peat moss fibers; flax; cotton; cotton linters; wool; sugar cane; paper; bagasse; bamboo; corn stalks; sawdust; wood; bark; straw; cork; dehydrated vegetable matter; whole ground corn cobs; corn cob light density pith core; corn cob ground woody ring portion; corn cob chaff portion; cotton seed stems; flax stems; wheat stems; sunflower seed stems; soybean stems; maize stems; rye grass stems; millet stems; and mixtures thereof.”

One reason that biomass is an attractive proppant is because the density of biomass is similar to that of water. This is why biomass is classified as a lightweight or ultra-lightweight proppant in the petroleum industry. The low density reduces proppant settling, which means it can be suspended in a flow with less gel than is needed to suspend heavier proppant (e.g., sand). Increasing the flow velocity further improves the ability to transport low density proppants, like biomass. These changes can reduce the cost of creating hydraulic fractures used to increase recovery of hydrocarbons. Large volumes of material would be required for SIRGE applications, so the cost of this material is an important consideration on economic suitability.

The process of using hydraulic fractures to raise the ground surface, as outlined by Germanovich and Murdoch in the SIRGE process, emphasizes the injection of solid compounds to cause significant amounts of uplift. The solid compounds, used to raise ground elevation, are intended to maintain the opening displacements of the walls of a hydraulic fracture. In SIRGE, these displacements result in the surface ground uplift. It is apparent to those of ordinary skill in the art that the same displacements of the fracture walls result in the same ground surface uplift regardless of how these displacements were created.

Proppants used in hydraulic fracturing applications have the same function of maintaining hydraulic fractures open. It is obvious to those of ordinary skill in the art that the solid compounds used in SIRGE, which are called “solids” by Germanovich and Murdoch, include any of the proppants used in hydraulic fracturing, including the long list of biomass materials (see above) provided by Burts in the U.S. Pat. No. 6,016,871 as well as including the lignocellulosic biomass materials listed by Allen (Allen, L. E., 2021, US Patent Application Publication, Pub. No. 2021/0324258 A1).

Hydraulic fractures are also filled with materials that serve purposes other than to maintain an opening displacement of the fracture walls, and one good example is practiced in the environmental industry. Environmental applications inject a wide range of compounds that are intended to create conditions that lead to the degradation of contaminants. For example, biomass injected into hydraulic fractures will be consumed by aerobic bacteria, which will reduce the concentration of oxygen and create redox conditions that favor the degradation of contaminants, including nitrate and trichloroethylene. Injecting biomass into shallow hydraulic fractures to control chemical conditions has been known for more than a decade (Slack, W., 2018, Declaration of Dr. William Slack in support of response to ex parte reexamination office action, U.S. Pat. No. 7,531,709, USPTO docket no. SCA-CCC-REEXAM).

Geometry and Inclination of Hydraulic Fractures.

The geometry of a hydraulic fracture, and in particular the inclination of the fracture is important for applications of hydraulic fractures at shallow depths. The reason for this is that fractures with inclinations that are about vertical tend to propagate upward and may reach the ground surface. If the material injected into the hydraulic fracture reaches the ground surface before the full desired volume of material has been injected, then it is inevitable that the hydraulic fracture will be smaller than planned and this is likely to limit the performance of the hydraulic fracture. Moreover, injected material reaching the ground surface may need to be collected and removed, which requires extra effort. Hydraulic fractures that are approximately horizontal can grow much larger and can store much greater volumes of material compared to hydraulic fractures that are vertical.

The inclination of a hydraulic fracture also plays an important role in the displacement of the ground surface that occurs when the fracture is created. Hydraulic fractures that are sub-horizontal will lift the overlying ground surface as a smooth dome. The upward displacement over a vertical hydraulic fracture is less than over a horizontal one, and the pattern tends to form one or two ridges rather than a smooth dome.

The orientation of a hydraulic fracture is controlled to a large degree by the direction of the minimum total compressive stress in the subsurface formation. The hydraulic fracture will open normal to the direction of minimum compressive stress, so this stress is horizontal when hydraulic fractures are vertical, and the minimum compressive stress is vertical when hydraulic fractures are horizontal. The direction of the minimum compressive stress depends largely on the geologic conditions and geologic history of the formation. In many locations the minimum compressive stress is horizontal at depths below about 1000 ft, which is the depth of most oil reservoirs. As a result, most hydraulic fractures in oil reservoirs are vertical. However, a depth of less than about 1000 ft in rock the direction of the minimum compressive stress is horizontal in many places. Hydraulic fractures are horizontal in shallow rock in many places as a result.

The state of stress in soils or sediments that have not been lithified to rock also depend on their geologic history, but it is more difficult to generalize compared to the state of stress in rock. Hydraulic fractures are predominantly horizontal in many shallow locations, but they are predominantly vertical in other locations. Hydraulic fractures are commonly flat-lying or about horizontal in the vadose zone above the water table in many locations.

Plastic in the Environment.

Carbon is about one half the mass of so called “bone dry” wood and it is a similar fraction of other biomass, but it also occurs in other materials. Plastics contain about 80 percent carbon by mass, for example. Plastic is durable compared to wood, so there is little concern that plastic will release the carbon it contains to the atmosphere. However, the durability of plastic has created a problem as waste plastics accumulate. Waste plastic almost always consists of mixtures of different plastic compositions and this has stymied efforts to recycle plastic. Waste plastics can be disposed of in landfills, but this is expensive and it has been less expensive to send waste plastic to other countries for disposal. In some cases, however, the disposal of waste plastic was done improperly and this has led to large volumes of waste plastic accumulating in the ocean. This has degraded the marine ecosystem, and a significant example of this problem is the so-called great Pacific Garbage Patch.

Another problem is that plastics tend to break down into small pieces, called microplastics. Microplastics are mistaken for food and mistakenly ingested by some organisms. In other cases, microplastics are inadvertently consumed because they are small enough to be undetected. Many fish and marine mammals have been found to contain microplastics, and microplastics have also been found in humans. Plastics have no nutritional value, and they can create blockages that disrupt digestive systems, or cause other problems that pose health risks to organisms across the food chain.

New uses of waste plastic are needed to create in incentive to prevent plastic wastes from entering the environment and damaging ecosystems.

Climate Change Adaptation and Flooding.

Rising sea levels have increased the risk of flooding caused by both large storms that create a catastrophic flood, and tides that create smaller, but more frequent nuisance floods. The problems and costs associated with flooding are projected to increase with the rising sea level. It is generally recognized that there are four options for reducing flood risk can be described using the acronym PARA: (i) Protect areas from flooding using barriers, like dikes, levees and sea walls; (ii) Accommodate rising water levels by raising the elevation of the ground surface; (iii) Retreat, which involves abandoning infrastructure and rebuilding elsewhere; (iv) Avoid building in flood-prone areas. Only the first two options, Protect and Accommodate, allow a community to remain in place in the face of rising sea-level. Protecting areas with dikes or levees is relatively straightforward, but it runs the risk of significant flooding if there is a failure in the dike system. Dike failures occurred with during Hurricanes Katrina and Sandy with catastrophic results, and dike failures occur in many locations worldwide with equally disastrous results (e.g., recently in South Sudan). A noteworthy example of the Accommodation method of flood protection is in the city of Galveston, where the ground elevation was raised by up to 5 m following a hurricane in 1900. The Galveston grade raising was one of the most successful flood control measures ever implemented, but it would be cumbersome to use construction methods from the early 1900s in a modern city.

Another approach to flood control by Accommodation is to implement the SIRGE strategy and inject solids into the subsurface to create hydraulic fractures that lift the ground surface. This strategy can be implemented at large scale without disrupting infrastructure.

### SUMMARY OF THE INVENTION

Preferred embodiments of a system and method for storing a solid material containing carbon at shallow depths in geologic formations have been described and illustrated in accordance with the teachings provided herein.

In one embodiment, carbon-bearing solid particles are injected into the subsurface where they are isolated from the atmosphere and thereby reduce the atmospheric concentration of carbon-bearing gases, such as carbon dioxide and methane. The carbon-bearing particles are mixed with water or another fluid to create a viscous slurry that can be pumped into a well or wells at pressures sufficient to displace or separate rock or mineral grains in subsurface geologic formations. The separated grains create space for the injected solid particles in a process similar to hydraulic fracturing. When the pressure decreases, the grains move together and compress the solid carbon-bearing particles into a lens. Compression of the particles prevents them from moving, thereby limiting the potential for leakage of the carbon to the atmosphere. In this embodiment, carbon in a solid phase is immobile in the fracture/lens, so it can be stored at shallower depths in a wider range of geologic settings, and with less stringent monitoring compared to storing CO2 in deep formations.

Another embodiment of this invention is to structure the injection process to manipulate the in-situ stress state in order to restrict upward propagation of hydraulic fractures. The orientation of lenses of injected particles plays an important role in isolating the particles from the atmosphere. Vertical orientations tend to propagate upward and may reach the ground surface, which comprises storage. A horizontal orientation is preferred because it has little risk of propagating upward and it is an efficient way of creating upward displacements of the overlying geologic formation. The horizontal orientation is achieved by selecting appropriate injection locations where the state of stresses is favorable for the horizontal fracture orientation. In some locations, however, the in-situ state of stress is such that it will cause hydraulic fractures to be steeply dipping. This is mitigated by creating multiple, small hydraulic fractures until the horizontal compression is increased sufficiently, so that new hydraulic fractures become about horizontal.

In another embodiment, displacements created by the injection process are used as a monitoring tool. A wide range of sensors and instruments are available to measure deformations and these data are integrated with mathematical models to predict the deformations caused by future injection. These predictions are used to guide the volume of carbon-bearing solid particles injected into each boring and the rate of injection to achieve the desired deformations.

### BRIEF DESCRIPTION OF DRAWINGS

FIG. 1 is an overview diagram of solid carbon particles derived from biomass injected to create a lens in the subsurface for storage.

FIG. 2 illustrates biomass or other solid compounds injected multiple times to create sufficient uplift of the ground surface to reduce the risk of flooding.

FIG. 3 shows injection of a large volume of fluid as either a single large event (left side), or as multiple smaller events (right side). Injection as a single large volume causes slurry to propagate upward and possibly reach the ground surface, but injecting as multiple small volumes creates horizontal lenses.

FIG. 4 illustrates multiple injections used to change the orientation of particle-filled hydraulic fractures. (a) illustrates the ambient stress field. (b) shows a vertical hydraulic fracture created in this stress field. (c) illustrates how vertical fractures can change the magnitude of the horizontal compressive stress. (d) shows how this will create conditions that result in horizontal hydraulic fractures.

FIG. 5 illustrates the method of adjusting the elevation and slope of the ground surface to affect the direction of water flow so that the effects of flooding are reduced.

FIG. 6 illustrates the method of injecting solid particles to store carbon with a system of sensors that measure displacements and use the data to control the injection process.

FIG. 7. illustrates multiple injections used to reorient hydraulic fractures by creating stress-reversal regions (hatched). (a) The largest initial (in situ) subterranean stress component is vertical. (b) The first hydraulic fracture or lens is vertical. (c) Creating a vertical hydraulic fracture reverses the magnitudes of the horizontal and vertical compressive stresses in a zone around the fracture and results in a horizontal fracture. Beyond the reversal zone, the hydraulic fractures are vertical. (d) The process is repeated with another reversal of stress and fracture directions.

FIG. 8 illustrates the process of dewatering and maintaining the water table after slurry injection. (a) A well configuration to be used for injection or dewatering. (b) Creating hydraulic fractures by injection of slurry consisting of solid particles and water. (c) Water leakage out of the fracture, closure of the fracture walls, pore pressure increase, and water table rise. (d) Water table becomes elevated (solid line) above the initial level (dashed line). (e) Pumping water out causes flow towards the well, the pore pressure decreases, and the water table falls. (f) Continued pumping lowers the water table back to initial conditions.

### ELEMENTS AND NUMBERING USED IN THE DRAWINGS AND DETAILED DESCRIPTION

(1) CO2 is removed from the atmosphere by photosynthesis and stored as biomass.

(1a) Degradation of biomass by biological processes that generate CO2 in the atmosphere. The CO2 generated by Step 1a is avoided by using Step 3., resulting in net removal of CO2 from the atmosphere.

(2) Biomass is processed into particles. This involves harvesting the biomass and chopping, grinding or milling the biomass into particles less than 1 cm in maximum dimension.

(3) Particles are injected into a water-saturated geologic formation for storage. The injection process creates lenses in subsurface geologic formations.

(3a) Lens of carbon-bearing particles created by injecting a slurry into a geologic formation

(4) Injection of biomass or other solid compounds, including biochar, plastic, coke breeze, paper, microplastic, plastic waste removed from the ocean.

(5) Upward displacement of the ground surface (uplift) created by injection.

(6) Flooding caused by storms, high tides, or similar. The ground surface is raised in neighboring areas, thereby reducing damage from flooding.

(7) Injecting a large volume of slurry as a single continuous injection event.

(8) A hydraulic fracture propagating upward, reaching the ground surface and depositing solid particles at the ground surface.

(10) Each injection creates a small lens of solid material in the vicinity of the injection casing. The result is an array of discrete, superimposed lenses in the vicinity of the injection casing.

(11) Maximum principal compressive stress is vertical and the minimum principal compressive stress is horizontal.

(12) A hydraulic fracture created under these conditions is vertical. This favors propagation upward that creates lenses extending to the ground surface.

(13) Pressure inside the vertical hydraulic fracture increases the horizontal compressive stress in the enveloping geologic formation. The vertical fracture is filled with solid particles so a net increase in horizontal stress persists even after the fluid pressure in the vertical fracture equilibrates with fluid pressure in the vicinity.

(14) Additional hydraulic fractures are created.

(14a) The horizontal compressive stress is increased as a result of creating multiple vertical hydraulic fractures, as shown in (14). This occurs until the horizontal compressive stress is greater than the vertical stress.

(15) Multiple vertical hydraulic fractures as shown in (14) are filled with solid particles so the increase in horizontal compressive stress persists after the fluid pressure equilibrates.

(16) Horizontal orientation of a hydraulic fracture resulting from the modifications to the stress field.

(17) Water during heavy rain flowing away from high elevations.

(18) Water during heavy rain accumulating in areas with low elevations, particularly areas that are closed basins. Infrastructure in low lying areas are particularly vulnerable to flooding due to runoff from higher elevations.

(19) Regions in low lying areas are selectively raised.

(20) Rainfall flows away from low lying areas that are selectively raised as shown in (19)

(21) Water accumulates in areas that are set aside for flood control instead of damaging infrastructure.

(22) Illustrates equipment that mixes solid carbon-bearing particles with a fluid to create a slurry. The slurry is pressurized with a pump.

(23) Slurry is injected into pipes or tubing that lead to borings. Valves are used to select which boring is used for injection.

(24) Equipment used to receive sensor data from (25), (26), (27), (28), (29) and calculate which boring is used for injection and how much volume is injected.

(25) A transit, GPS, lidar or similar ground-based system for measuring displacement of locations at the ground surface.

(26) Tiltmeter at the ground surface used to measure changes in inclination of the ground surface, or buildings or other infrastructure at the ground surface, or sensor to make seismic or other geophysical measurements.

(27) Sensor in the shallow subsurface to measure normal strain, displacement, or tilt caused by injection.

(28) Sensors distributed vertically in the geologic formation and or along the injection casing to measure vertical strain or displacement caused by injection, to detect geophysical movement within the formation, and/or to make electromagnetic measurements.

(29) Lidar or photogrammetric system in the air to measure displacement of the ground surface.

(30) Data connection between (24) data acquisition and control computer and (22) injection system.

(31) Solid carbon-bearing particles in bulk form ready to be mixed as a slurry and injected.

(32) An initial condition where the vertical compressive stress is greater than the horizontal compressive stress.

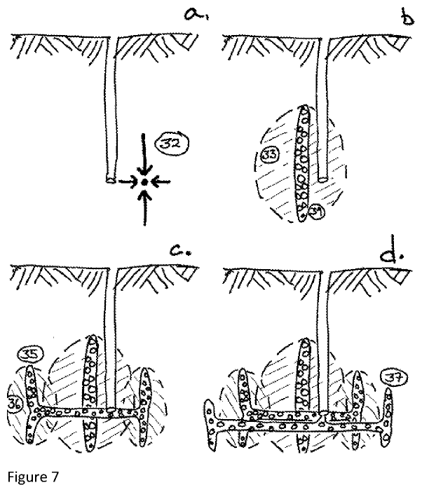

(33) A vertical hydraulic fracture filled with solid particles and created in the stress state shown in FIG. 7a.

(34) A hatched region showing the stress reversal region created by the vertical hydraulic fracture.

(35) Hydraulic fracture is horizontal in the stress reversal region and it becomes vertical outside of that region.

(36) Region where the relative magnitudes of the principal stresses have been reversed (hatched) by the vertical segment of the hydraulic fracture shown as (35).

(37) A horizontal hydraulic fracture in the stress reversal region. The stress reversal region has expanded laterally by the hydraulic fracture (35), and this accounts for a greater lateral length of this horizontal hydraulic fracture compared to the one in (35).

(38) Casings to be used for injection on either side of well (39).

(39) A conventional well used for dewatering or pore pressure reduction.

(40) Slurry is injected into the casings (38) and creates hydraulic fractures.

(41) Pressure from the injection process displaces the fractures walls, as shown by the black arrows.

(42) Water leakage out of the fracture that occurs after injection, as shown by the wavy grey arrows.

(43) The walls of the fracture close, as shown by the black arrows. Closure of the fracture walls immobilizes the injected carbon-bearing particles and prevents them from migrating upward.

(44) Leakage of water out of the fracture causes the pore pressure to rise and this causes the water table to rise.

(46) The water table becomes elevated as a result of one or multiple injections of water.

(47) A pump associated with conventional dewatering well (39).

(48) Water that has leaked out of the fracture to flow toward well (39).

(49) The pore pressure decreases and the water table falls.

(50) Pumping continues as needed to decrease the pore pressure and lower the water table back to initial conditions (51).

(51) Initial pore pressure.

### DETAILED DESCRIPTION OF THE INVENTION

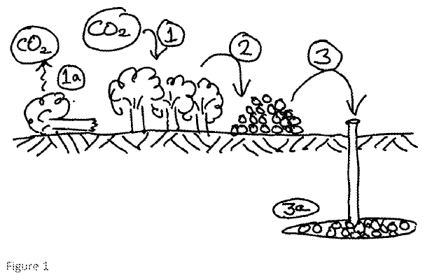

A system and method according to this invention consist of storing carbon as solid particles that are injected into the subsurface where they are isolated from the atmosphere and thereby reduce the concentration of carbon-bearing gases, such as carbon dioxide and methane, in the atmosphere (FIG. 1). The carbon-bearing particles are mixed with water or another fluid to create a viscous slurry that can be pumped into a well or wells at pressures sufficient to displace or separate rock or mineral grains in subsurface geologic formations. The separated grains create space for the injected solid particles. When the pressure decreases the grains move together and compress the solid carbon-bearing particles into a lens. Compression of the particles prevents them from moving, thereby limiting the potential for leakage of the carbon to the atmosphere. FIG. 1 illustrates the general process where (1) CO2 is removed from the atmosphere by photosynthesis that creates biomass, (2) biomass is processed into particles, and (3) particles are injected into a water-saturated geologic formation for storage. The lens created by injecting the carbon-bearing particles is shown in (3a). This process creates a net storage of carbon by avoiding (1a), the degradation of biomass by biological processes.

Unless otherwise stated, the term “well” means any vertical, horizontal, or inclined straight or curved well, borehole, casing, subsurface pipe, or boring. These terms can be used interchangeably with each other and the term “well”.

The terms “solid particles”, “solid material”, “solids”, and “solid compounds” have the same meaning, used interchangeably in this disclosure, and include carbon-bearing particles, biomass particles, and plastic particles.

The term “biomass” means the following carbon-containing materials, including those listed in the background section: comminuted plant materials of nut and seed shells or hulls of almond, brazil, cocoa bean, coconut, cotton, flax, grass, linseed, maize, millet, oat, peach, peanut, rice, rye, soybean, sunflower, walnut, and wheat; rice tips; rice straw; rice bran; crude pectate pulp; peat moss fibers; flax; cotton; cotton linters; wool; sugar cane; paper; bagasse; bamboo; corn stalks; sawdust; wood; bark; straw; cork; dehydrated vegetable matter; whole ground corn cobs; corn cob light density pith core; corn cob ground woody ring portion; corn cob chaff portion; cotton seed stems; flax stems; wheat stems; sunflower seed stems; soybean stems; maize stems; rye grass stems; millet stems; lignocellulosic material including plant material, leaves, grass-trimmings, wood pulp, rice-husks, corn stover or any plant-based product including wood ash and biochar; phytoplankton and algae; and mixtures thereof. To those of ordinary skill in the art, the extension of this list is apparent.

In this disclosure, the terms “sufficient”, “sufficiently”, “essential”, and “essentially” are used to identify and characterize quantities with a magnitude that is close enough to have the intended result. So, it is unnecessary to provide specific numerical values to enable those with ordinary skill in the art. These terms are used when the difference between the intended and realized measures is insignificant and does not need to be determined exactly. This difference includes measurement errors, tolerances, random noise, uncertainties in boundary and initial conditions, and other factors known to those of ordinary skill in the art.

The term “water” means pure water, or water with any type of solute or small particles that are present in such concentrations that the “water” viscosity and density are sufficiently close to that of pure water. For example, in this disclosure, seawater and reservoir pore water are examples of “water”, and other examples will be apparent to those of ordinary skill in the art.

The term “fluid” means water or a mixture of water with at least one gas, liquid, solute, solid, gel, and/or another viscosifier.

The terms “lens”, “hydraulic fracture”, and “fracture” mean the same and used interchangeably in this disclosure.

Comparison to Hydraulic Fracturing.

One way that the essence of this invention differs from other applications is due to the chemical composition of the injected particles. Most carbon-bearing particles are soft and so they would be readily compressed by stresses in the subsurface. This would make them poorly suited for well stimulation. Moreover, most carbon-bearing particles are unable to facilitate chemical reactions that degrade contaminants, so they are of little value in the environmental remediation industry. Similarly, most carbon-bearing particles will not solidify like cement or grout, so they would be poorly suited to applications intended to solidify soft ground.

The chemical composition of the injected carbon-bearing particles has the potential to affect the chemistry of groundwater when practicing this invention. It is possible that compounds could dissolve and be transported out of the carbon-bearing particles into groundwater. It is also possible that microbes could interact with the carbon-bearing particles and create other chemicals that dissolve in groundwater. The chemicals involved in this process and the extent that it occurs will depend on the chemical composition of the injected particles, as well as the chemical composition and conditions in the vicinity of the location where the particles are injected. Wood or other common, untreated biomass has not been reported to produce chemicals by degradation or leaching that are groundwater contaminants as recognized by a maximum contaminant limit by the USEPA. Nevertheless, it is possible that compounds could be created that have a negative effect on water quality when practicing this invention. The impact of this possibility can be minimized by limiting the practice of this invention to areas that are separated from potable groundwater sources, or aquifers. The separation can be accomplished by a confining unit of sufficiently low permeability and large thickness so the flow from the area of the invention to aquifer is negligible.

It is also important that compounds released from the injected material have little interaction with surface water where they could affect the aquatic ecosystem.

The salinity of groundwater in many coastal areas is greater than about several percent.

This salinity currently renders the groundwater of little practical use.

Benefits from Ground Displacement.

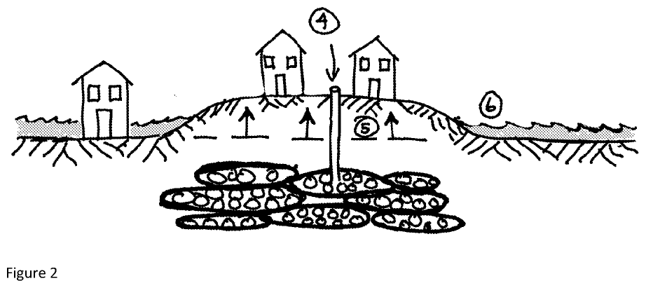

The process of injecting and storing carbon particles in geologic formations has additional benefits related to storing materials and displacing geologic formations that are used to increase the value of the invention. A benefit is realized by using the upward displacement (5) of the ground surface to change the depth of water accumulating at the ground surface (FIG. 2). This is accomplished by repeating the injection process (4) many times at the same location to cause upward displacements (5) of up to about 10 m. Increasing the average elevation of the ground surface is one of the best methods of reducing the risk of catastrophic damage during flooding (6).

A related benefit is to raise the elevation by different amounts in different areas to change the slope of the ground surface. The slope of the ground surface is an important factor in controlling the hydraulic gradient of water that has accumulated at the ground surface. One aspect of this invention is to alter the ground surface to control the hydraulic gradient and the direction of water flow when water accumulates on the ground surface during high tides, or severe storms. This provides a tool for engineers to design how water flows off of one area and onto a neighboring area. Many areas that are currently prone to flooding receive runoff from neighboring areas that exacerbate the severity of the flood. This invention allows that effect to be mitigated by controlling the hydraulic gradient.

The terms “upward displacement” and “uplift” have the same meaning of predominantly vertical displacement when the magnitude of the horizontal component of the displacement vector is sufficiently small compared to the magnitude of the vertical component, and this relation holds over the sufficiently large part of the displaced region. In this disclosure, terms “upward displacement” and “uplift” are used interchangeably.

The invention is based on the SIRGE method of Germanovich and Murdoch, which is a method of creating upward displacements of the ground surface over large areas of about an acre or hectare or greater by using at least one injection of a slurry of carbon-bearing solid particles and liquid into at least one boring into an underlying geologic formation, wherein the solid and liquid are mixed to form a slurry and injected with a pump. This slurry of solid particles and liquid is injected at sufficient pressure to create at least one lens (FIG. 1 and FIG. 2) consisting of solid particles in the underlying geologic formation. Injecting solid particles containing carbon creates the upward displacement of the ground surface. The injected carbon-containing solid particles remain in the lens or lenses created in the underlying geologic formation and make the upward displacements of the ground surface permanent (FIG. 2).

The invention enables injecting solid particles in differing amounts in different areas to alter the slope of the ground surface. The invention further enables altering the slope of the ground surface to affect the flow of water. The invention also enables inducing a displacement field that reduces the creation of localized wet areas, which results in many benefits apparent to those with ordinary skill in the art. In particular, reducing the creation of localized wet areas can provide habitat for disease vectors, such as mosquitos that carry malaria, or dengue fever.

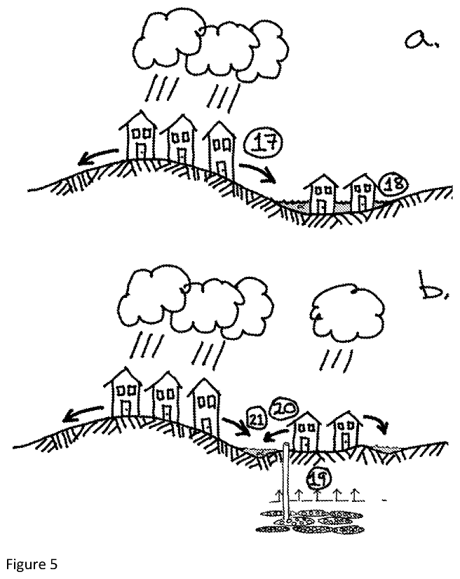

FIG. 5 illustrates the method of adjusting the elevation and slope of the ground surface to affect the direction of water flow so that the effects of flooding are reduced. FIG. 5a shows water flowing during heavy rain from high elevations (17) and accumulating in areas with low elevations (18), particularly areas that are closed basins. Infrastructure in low lying areas is particularly vulnerable to flooding due to runoff from higher elevations. FIG. 5b shows regions (19) in low lying areas selectively raised so that rainfall (19) flows away from these areas and accumulates in areas (21) that are set aside for flood control.

Subsidence can affect the flow of water in detrimental ways and this invention provides a means for correcting this problem. Canals or aqueducts are designed to contain water and they slope steadily in one direction to cause the water to flow. Subsidence can drop the elevation of certain parts of a canal or aqueduct below the elevation of other parts that are downstream. This causes water to spill out of the canal or aqueduct. This invention can be used to raise the elevation of the subsided area, which is greater than 1 hectare, in order to restore the original hydraulic gradient.

Dikes, levees, floodgates, dams and related structures are used to impound water to a certain elevation and thereby control flooding. Their effectiveness is reduced when subsidence lowers the crest of a flood control structure. Dikes and levees are common in deltas, for example, where the rate of subsidence can be in the range of about 1 to several cm per year. These structures need to be raised periodically to maintain a certain level of flood protection, which is based on the elevation of their crest. This invention can be used to store carbon beneath levees, dikes, or floodgates to offset the effects of subsidence. The injection process can be done to keep pace with subsidence and maintain a current level of flood protection, or it can be used to raise elevations and improve the level of flood protection. It is obvious that the injection process would be done deep enough so the integrity of the flood control structure is unaffected.

Underground mining creates cavities that collapse when the mine is abandoned, and this causes subsidence of the overlying geologic material that can damage overlying infrastructure or threaten the safety of people or animals. A benefit of this invention is to raise the ground surface that has subsided due to underground mining. The cavity created by the underground mine can also be filled with injected particles of carbon-bearing material. This provides a useful location for storing carbon, and it will also help reduce the effects of subsidence. Similarly, subsidence caused by removal of hydrocarbon fluids or groundwater can be mitigated.

This invention comprises a method for raising ground elevations over an area greater than 1 hectare combined with other methods that raises ground elevations over smaller areas. Compensation grouting is a method used to raise the elevation of the ground surface or to raise buildings to compensate for localized subsidence or other effects. This invention includes using compensation grouting to make local adjustments to the elevation of the ground surface while raise the ground surface on average over areas of about 1 hectare or greater.

Carbon-Bearing Particles.

This invention uses carbon-bearing particles that are generally smaller than about 1 cm in maximum dimension and preferably smaller than about 0.5 cm. Particles of this size are sufficiently small to be injected into hydraulic fractures that have been opened by internal fluid pressure. Such particles may occur naturally, but preparing a solid material containing carbon in the form of small particles could require grinding, milling, or chipping equipment.

Plant biomass is one source of carbon-bearing particles that is used with the invention.

Would is a sustainable biomass, which is commonly processed with wood chipping equipment. Wood is milled into particles of suitable sizes. Entire logs can be milled using a chipper and hammer mill to create particles of suitable size. Residues collected from the forest after logging, or the residues remaining after milling larger pieces of wood to create lumber are suitable. Residues remaining after crops have been harvested can also be suitable. These residues include corn stalks, peanut shells, wheat stalks and chafe, as well as stubble, stems, leaves and seed pods from other crops. Other suitable residues include materials remaining after crops have been processed, including husks, seeds, bagasse, and roots.

The term “sustainable biomass” means that the biomass is available and replenishable at a rate that is sufficiently sustainable. Crop waste and forestry residues are examples of sustainable biomass, and many other examples are known to those skilled in the art.

The term “wood chipping equipment” includes wood chipper, micro-chipper, hammer mill, grinder, sawdust machine, and other devices known to those of ordinary skill in the art. In this disclosure, the term “wood chipping equipment” is synonymous to the term “biomass chipping equipment” and includes disintegration of other biomass types into sufficiently small particles.

Essentially any biomass that could be burned to create energy could alternatively be injected into the subsurface as part of this invention.

Plastic or paper material that is processed to less than 1 cm in maximum dimension is also suitable for use in the invention. Plastic material of mixed compositions that has already been used for its initial application is commonly unsuitable for recycling by current means. It can be processed into particles of suitable size and injected. Plastic materials that cannot be recycled are typically disposed of in landfills. Landfill space is expensive and in short supply in many locations, so providing an alternative to storage in landfills is a benefit of this invention.

The plastic could be a waste product that could be regarded as litter or a nuisance in the environment, or that would fill landfill space.

Landfills are unavailable in many locations either because they are too expensive or the necessary land is unavailable. The disposal of plastics in these areas without readily available landfills is done in an unsecure manner and this poses a threat to the environment. Many discarded plastic products have washed into waterbodies where they damage ecosystems. Plastics are degraded into small particles, called micro-plastics, which are becoming a universal ecological concern. This invention provides an alternative method of disposing of plastic products and reducing threats of plastic contamination, including microplastics.

The term “waterbody” means any body of surface water, such as a waterway, lake, river, pond, ocean, and other surface water bodies known to those of ordinary skill in the art.

Eight million tons of discarded plastic products are estimated to accumulate in the ocean every year. This has resulted in some large concentrations of plastic products, including the so-called great plastic garbage patch in the Pacific Ocean. Methods have recently been developed to recover and remove plastic from the ocean, but suitable methods for disposing of this recovered plastic are unavailable. Most of the plastic recovered from the ocean can be milled to particles smaller than one cm in maximum dimension and injected into geologic formations as part of this invention.

Paper is another carbon-bearing solid material that is suitable for use in the invention. Paper should be processes into particles that are less than about 1 cm in maximum dimension.

Harmful algae blooms can release toxins or consume oxygen with detrimental impacts on coastal ecosystems. Methods are available for removing harmful algae from the environment using harvesting equipment, but it can be difficult to dispose of the harvested algae. This invention includes injecting algae into the subsurface. Algae is injected directly, or after some processing to increase the solid-water ratio. Algae can be grown intentionally using procedures designed to maximize the rate of growth and therefore the rate of carbon storage. Other aquatic plants, such as kelp, could be intentionally grown and harvested for the purpose of carbon storage by injecting into the subsurface. Additional processing may be required to render some aquatic plants suitable for injection.

In this disclosure, nuisance species are sargassum, duckweed, hydrilla, water hyacinth, harmful cyanobacteria, other algae, and similar nuisance species known to those of ordinary skill in the art.

Microbial Degradation.

It is widely recognized that carbon-bearing solid materials can be degraded by microbes to produce carbon dioxide and methane. This occurs in landfills, for example. The rate at which carbon dioxide and methane are produced varies with the environment and with the chemical composition of the carbon-bearing material. Small rates of production of these gases would be accommodated by dissolution of the gas into water overlying the injected carbon-bearing materials. Methanotrophic bacteria will degrade methane in the presences of water and oxygen. Conditions that are suitable for the degradation of methane by methanotrophic bacteria will occur in many of the locations where this invention is practiced. These factors will limit the upward flux of methane, and it would ultimately limit the rate of mass transfer of carbon to the atmosphere. The rate of gas production in reduced conditions is slower than in oxidizing conditions. For this reason, a preferred embodiment of the invention is that it is conducted in a geologic formation that is saturated with water and at least 1 meter below the water table.

It is commonly recognized that gas will be produced by the degradation of lignin at rates that are significantly slower than degradation of cellulose or other similar carbon-bearing materials. Wood contains a higher concentration of lignin than paper or some crop waste, so it will degrade to produce gas at a slower rate than those other materials. The carbon molecules in plastic are strongly bonded and it is generally recognized that natural degradation of plastic does not produce gases at any significant rate.

The rate of gas production is expected to be slow when wood particles are injected in saturated conditions, but it could be larger when paper or other carbon-bearing materials are used in this invention. Methods of removing gases from the subsurface using pumps or wind-powered turbines are available and they are used as part of this invention to reduce the concentrations of free gas. Methods to limit methane production by application of Antimethanogenic Reagents also are used as part of this invention.

Mechanics of Injecting Solid Carbon-Bearing Particles.

The primary embodiment of this invention is the use of pressure to create an opening or cavity at the time of injection and to fill this cavity with solid particles. This process is similar to hydraulic fracturing for well stimulation or environmental remediation, or to compensation grouting used to make small adjustments in the elevation of building foundations affected by settling.

The mechanical processes that occur during the invention are similar to the processes during hydraulic fracturing. One important difference is that most applications of hydraulic fracturing use one or several injections of solid material to achieve a particular goal. In contrast, several dozen to as many as 1000 injections of solid particles will occur from a single location as part of this invention. Thus, an important aspect of this invention is solid particles are placed in the subsurface as many injections each of small volume with sufficient time between each injection to allow the fluid fraction of the slurry to flow into the enveloping geologic formation. Many small injections are used instead of one large injection in order to limit the transport of solid materials upward above the point of injection. Upward propagation of a hydraulic fracture could occur where the density of the fluid inside of the fracture is less than the density of the geologic formation. In this case, the fracture can propagate upward due to buoyancy.

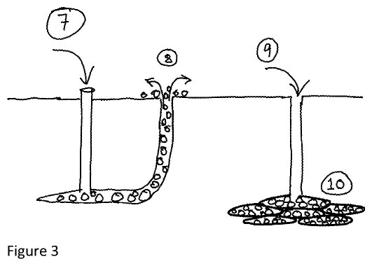

This effect is particularly acute where hydraulic fractures are vertical (FIG. 3). It is generally accepted that the orientation of a hydraulic fracture will be largely controlled by the in-situ stress state, where vertical hydraulic fractures are created in geologic formations where the maximum compression direction is vertical. This stress state is common in sediments at depths of less than 20 m, and it is also common in sediments and rock that are deeper than 300 m to 500 m. These conditions are likely to occur in many locations where the invention is practiced. Upward propagation of a vertical hydraulic fracture could cause the injected solid material to reach the ground surface and this would reduce or eliminate the effectiveness of the invention.

The problem of vertical hydraulic fractures reaching the ground surface is illustrated in FIG. 3. Injecting a large volume of slurry as a single event (7) can create a hydraulic fracture that reaches the ground surface (8), or that propagates upward sufficiently far so it is no longer in the required zone. Injecting a large volume of solid particles as multiple small injections (9) creates multiple lenses (10). Periods of no injection are used so the fluid pressure created by injection and decrease and approach the equilibrium pore pressure.

Multiple Injections to Control Form.

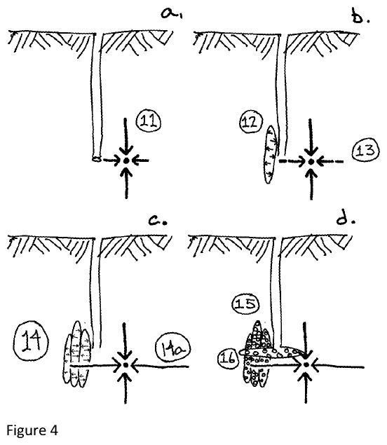

One embodiment of this invention is to structure the injection process to manipulate the in-situ stress state in order to restrict upward propagation of hydraulic fractures, where the term “restrict” is a short-hand for “reduce, arrest, or eliminate”. This process uses the effect that a hydraulic fracture will alter the state of stress in its vicinity. For example, in a geologic formation where the maximum compressive stress (11) is initially vertical (FIG. 4a), the first hydraulic fracture (12) that is created will be vertical (FIG. 4b) and will tend to propagate upward if it is filled with a slurry with a density that is less than the enveloping formation. This is illustrated by (8) in FIG. 3 and by (34) in FIG. 7b. This fracture is pressurized and its internal pressure applies a load that opposes, and therefore increases the magnitude of the horizontal compression (13) in FIG. 4b). The injected solid materials cause the increase in horizontal stress to be preserved after the injection pressure has diminished (FIG. 4c and (33) in FIG. 7b). Repeating this process would likely create another vertical fracture that would further increase the horizontal compressive stress, as illustrated by (14) and (14a) in FIG. 4c. The height of these fractures is short if the injected volume is small, and this limits the risk of upward propagation. Repeating the process will create vertical fractures (15) that increase the magnitude of the horizontal compressive stress until the horizontal compression is greater than the vertical compressive stress (FIG. 4d). At this time, the relative magnitudes of the horizontal and vertical compressive stresses have reversed. Hydraulic fractures created after this time will be horizontal, as shown by (16) in FIG. 4d. Further injection into horizontal fractures will displace the overlying geologic formation upward, but the vertical compressive stress will be largely unchanged. This is because the vertical stress is essentially the product of unit weight and depth of hydraulic fracture, which are unchanging through the creation of successive hydraulic fractures.

The stress sign convention used in this disclosure is such that compressive stresses are positive.

The process of creating a vertical fracture will increase the horizontal compression in the neighboring geologic formation. It is possible that creating one vertical hydraulic fracture can increase the horizontal compression enough so the relative magnitudes of the horizontal and vertical compressive stresses are reversed in a zone around the fracture. This is called the “stress reversal zone and is illustrated with hatching in (33) (FIG. 7b) and (36) (FIG. 7c). A hydraulic fracture created in the stress reversal zone will be horizontal, but it can change orientation and become vertical when it propagates outside of the stress reversal zone and into the zone of the ambient stress state. The ambient stress state is shown in (32) (FIG. 7a). However, the vertical fracture (35) (FIG. 7c) will itself create a stress reversal zone (36), which will increase the size of the region where hydraulic fractures are horizontal (37) (FIG. 7d).

The process of successive injection of small hydraulic fractures will therefore create horizontal hydraulic fractures eventually even if the first few hydraulic fractures are vertical (FIG. 4c and FIG. 7). This effect is also an important way to address changes in the stress state caused by injection. Injection solid particles into hydraulic fractures will lift and stretch the overlying geologic formation. This reduces the horizontal compression and eventually it will lead to the creation of vertical fractures because the vertical compression will be greater than the horizontal compression. However, the process of stress manipulation with successive creation of small hydraulic fractures will reverse this effect.

Vertical hydraulic fractures will create some upward displacement of the ground surface, but larger displacements will occur above horizontal hydraulic fractures. As a result, the process of stress manipulation through successive injection of small fractures serves to both limit upward propagation and release of injected material, and it also improves the ability to raise the ground surface.

The size of a fracture that is “small” in this invention depends on the depth where the injection originates. A fracture is considered small when its greatest length is small relative to its original depth. This is because a hydraulic fracture that is small relative to its depth will have little interaction with the ground surface. For example, hydraulic fractures that are roughly circular are considered small when the ratio of radius to depth is about 1/100 or 1/10 or ½.

It is possible that the process of multiple injections will in some cases be unable to limit upward propagation. For example, many injections at one depth will increase the horizontal compressive stresses in the overlying geologic formation and this could cause a hydraulic fracture to propagate upward and reach the ground surface. The probability of this occurring will increase if the volume of the injected material exceeds a critical value that is sufficient to create a large hydraulic fracture. Once a hydraulic fracture as propagated from the current injection depth to the ground surface, the probability that subsequent injections will create hydraulic fractures that propagate to the ground surface will increase. This is undesirable because carbon-bearing material that reaches the ground surface will not be isolated from the atmosphere, nor will it contribute to the permanent upward displacement that is a benefit of this invention. A method of this invention addresses this problem by creating a new injection point at a depth that is between 0.5 m and 100 m greater than current injection depth. The stress state below the original injection depth will be only slightly affected by the original injections. Hydraulic fractures created by injections at this greater depth will follow a path controlled by the local stress state, so these fractures will follow a path that is independent of the path created at the original depth that leads to the ground surface. The process of subsequent injections is then resumed at this greater depth.

The feasibility of creating multiple injections of wood, and using these injections to suppress upward propagation has been demonstrated in a field test. A slurry was created using wood particles that were sieved so the particles were less than 6 mm in maximum diameter. The slurry was injected into pipes sealed into the ground and open at the bottom at a depth of 8 ft. In one experiment, approximately 1.5 m3 of slurry was injected at one time. Injection was terminated because the slurry reached the ground surface. This experiment created a thin layer (a few mm thick) of approximately 0.2 m3 bulk volume of wood particles. In another experiment, the process was changed to use 0.3 m3 during each injection, and to repeat the injection process. The injection process was repeated 30 times, resulting in a much thicker layer (25-40 mm thick) with a bulk volume of approximately 5 m3.

Monitoring Deformation to Guide the Injection Process

Injecting solid particles into the subsurface according to this invention will deform the enveloping geologic formation and this deformation presents important benefits in the form of raising ground elevations, but it also presents an opportunity for making measurements that can be used to guide the injection process. The basic strategy is to measure deformation and then use mathematical model of the injection process to interpret the deformation data. The interpretation process can be done heuristically with the mathematical model providing qualitative insights, or it can be done using inversion methods that estimate critical parameters by matching the mathematical model to the data.

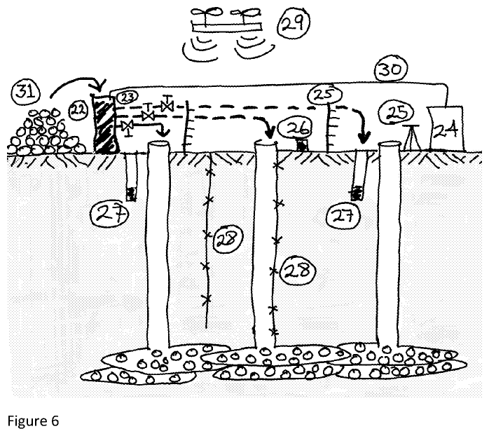

The deformation methods outlined above in the background section are currently available to measure the deformation caused by the injection process. This invention includes the use data from deformation sensors to interpret the effects of injection and to guide decisions during the injection process (FIG. 6). For example, tiltmeters have been used for several decades to measure deformation during hydraulic fracturing. The tilt data are inverted using mathematical models of the hydraulic fracturing process to estimate the size, aperture and orientation of the hydraulic fracture. A similar process has been used to interpret deformation occurring during injection that increases pore pressure, but that does not create hydraulic fractures.

In this invention, deformation data are used to estimate the location and orientation of lenses of solid particles using mathematical inversion methods. The information about location and orientation is used to guide the injection process to reduce the probability that injected slurry will migrate upward. For example, the volume of each injection would be reduced, and the time in between injections would be increased when the deformation data indicated upward propagation.

Some types of deformation data will be important to creating a uniform distribution of upward displacement. For example, measurements made at the ground surface with an optical level, or lidar can be used to directly measure the upward displacement. However, those measurements are difficult to make with automated sensors and their resolution is limited. In contrast, subsurface sensors, like strainmeters, tiltmeters, extensometers or optical fiber strain sensors, can measure strain with precision that is much higher than measurements at the ground surface. However, subsurface sensors cannot measure the upward displacement of the ground surface, or structures at the ground surface, and these data are important for monitoring, assessing, and controlling the injection process and injection parameters.

The terms “sensor”, “displacement sensor”, and “deformation sensor” have the same meaning and include strainmeter, stressmeter, tiltmeter, extensometer, optical fiber strain sensors, LVDT (Linear Variable Differential Transformer), Rotary Variable Differential Transformer (RVDT), Differential Variable Reluctance Transducer (DVRT), strain gauge and any other strain sensors and inclination sensors known to those skilled in the art. In this disclosure, the terms “sensor”, “displacement sensor”, and “deformation sensor” are used interchangeably.

A surface sensor conducts surface measurements, that is measurements done at the ground surface. Surface sensors include an optical level, total station, terrestrial lidar, global positioning system, interferometric synthetic aperture radar, and other sensors, based on the methods to measure the location or elevation of a point or multiple points at the ground surface, known to those of ordinary skill in the art.

A subsurface sensor conducts subsurface measurements, that is, measurements done in the subsurface. In this disclosure, subsurface sensors include a borehole strainmeter, tensor strainmeter, borehole tiltmeter, borehole extensometer, strain gauge, sensors based on the Brillouin or Raleigh scattering and using optical fibers, sensors based on the Coherence-length-gated Microwave Photonics Interferometry, long baseline tiltmeter or strainmeter, and other subsurface sensors known to those of ordinary skill in the art.

The term “injection parameters” includes the volumes of injected fluids and/or solids, the time of injection, the injection rate, the pressure of injection, the time between successive injections at each boring and other injection parameters known to those of ordinary skill in the art.

As part of this invention, machine learning methods such as artificial neural networks, are used to correlate subsurface strain measurements with measurements of displacement of the ground surface or of built structures or infrastructure. This creates a mathematical function that predicts displacements that occur based on measurements of subsurface strains at selected points. This invention uses machine learning methods to correlate displacements with parameters that can be controlled during injection. These parameters include the timing and magnitude of the pressure, rate, and/or volume that is injected into each individual well (FIG. 6). This provides a method for selecting the injection volume, pressure or rate at particular wells in order to achieve the preferred displacements of the ground, structures or infrastructure.

The terms “strain measurements”, “displacement measurements”, and “deformation measurements” have the same meaning and include measurements of strains, displacements, tilts, tilt and strain gradients, and measurements of other characteristics of material deformation known to those of ordinary skill in the art. These terms are used interchangeably.

It is important to be able to control the distribution of upward displacement in order to reduce the potential detrimental effects of non-uniform displacement on infrastructure, and in order to construct the slope of topography that causes water to flow in a particular direction. This invention includes the use of upward displacement data that is either measured directly or that is determined using machine learning from subsurface displacement data in order to guide the injection process.

This invention also includes using machine learning to correlate injection parameters, including the volume, rate and pressure, with the upward displacement at one point or at many points. This process creates a mathematical relationship between the upward displacement and the injection parameters. This process uses measurements of upward displacement directly, and it also uses measurements from strain sensors. This includes an artificial neural network to create this mathematical relationship.

The injection process requires decisions about the volume of fluid and solid particles to inject and the duration of injection, and the duration of the time in between injections. These quantities are selected to maximize the rate at which particles are injected while avoiding negative effects of injection. One of the negative effects is upward migration of the solid particles. Another negative effect is the creation of displacements, or displacement gradients that could damage or have other detrimental effects on surface infrastructure, like houses, roads, bridges, buildings, utilities. This invention includes the use of displacement data directly, or displacement data combined with machine learning to make decisions about the volumes of fluid or solid, the duration of injection, the duration of the time between injections to reduce these detrimental effects. One example of this aspect of the invention is the decision to increase the volume of particles injected into a boring that underlies an area where the upward displacement is less than in neighboring areas.

The process of measuring deformation and using the data to control the injection process is shown schematically in FIG. 6, which shows solid carbon-bearing particles in bulk form (31). The solid particles (22) are transported to equipment that mixes the particles with a fluid to create a slurry. The slurry is pressurized with a pump. Slurry (23) is injected into borings. Valves are used to select which boring is used for injection. (24) shows equipment used to receive sensor data from (25), (26), (27), (28), (29) and calculate which boring is used for injection and how much volume is injected, where (25) illustrates a transit, total station, GPS, lidar or similar system for measuring displacement of locations at the ground surface, (26) is the tiltmeter (26) used to measure changes in inclination of the ground surface, (27) is a sensor in the shallow subsurface to measure normal strain, displacement, or tilt caused by injection, (28) illustrates sensors distributed vertically in the geologic formation and/or along the injection casing to measure vertical strain or displacement caused by injection, (29) is a lidar or photogrammetric system in the air to measure displacement of the ground surface, (30) shows data connection between the data acquisition system (24) and control computer, and (22) is the injection system.

Injection into Pore Space.

The injection of solid particles into subsurface geologic formations will either displace the solid framework of the geologic formation in a process similar to hydraulic fracturing, or it will cause the solid particles to enter the pores of the geologic formation. Karst is a term used to describe geologic formations that are composed of limestone, gypsum, halite or other soluble rock that contain cavities, tubes, caves, pores or other open structures produced where the solid rock has been dissolved. The dissolution structures in karst are commonly larger than 1 cm, so they are large enough to accommodate the solid particles injected during this invention. Thus, one embodiment of this invention is to inject carbon-bearing particles into karst conduits. This would be particularly well suited in areas where karst includes large cavities filled with saline water that do not support terrestrial ecosystems, and these karst systems are already used for waste disposal. The Boulder zone in the Floridan aquifer is one example. This type of karst aquifer is suitable for this invention.

However, this should only be done after careful selection of suitable locations. Water flows through the subsurface at rates of about 0.1 to more than about 1 m/s in areas where karst is actively forming and this would likely cause the injected particles to be washed out and transported into surface ecosystems. Some karst areas are recognized as unique ecosystems, and the Edwards aquifer in Texas and the aquifer containing Mammoth Cave in Kentucky are two examples. Injecting into such karst systems would damage these unique ecosystems and would be an unsuitable application of this invention.

Effects of Geology.

Geologic conditions will affect the performance of this invention. The original state of stress in the geologic formations where particles are injected will be affected by many factors and the geologic history of the geologic formation is one example. The process of deposition of sediments, burial beneath additional sediments and subsequent erosion of the overlying materials are particularly important. The process of deposition of sediments and burial beneath additional sediments is known to consolidate the sediments, which affects both the density and the stress state. These sediments are referred to as “normally” consolidated because the degree of consolidation as measured by an oedometer test is consistent with the vertical stress created by the unit weight and depth of the overlying sediments. Normally consolidated conditions are expected to occur in sediments that have been deposited recently. They can also occur in sediments that were deposited at some time in the past, but their deposition occurred after the last time the area was subjected to a drop in the relative sea level. In this case, a drop in the relative sea level could occur by actual change in the level of the sea, or by uplift of the sediments.

A drop in the relative sea level that is large enough to expose sediment to the atmosphere will in many cases lead to erosion of the sediments. Removing sediments by erosion will reduce the vertical compressive stress on underlying sediments, but in many cases the degree of consolidation will be largely unaffected and will be similar to the degree of consolidation created by the maximum depth of burial. Conditions where the degree of consolidation exceeds that which would be created by stresses caused by the overlying sediments are sometimes called “overconsolidated.” The process of erosion is therefore expected to cause overconsolidated conditions in underlying sediments. Processes of wetting and drying that occur from rainfall and drainage in the vadose zone may also cause sediments to become overconsolidated when they are uplifted and exposed.

The surface that was once the ground surface and subject to erosion, but that is now covered by younger sediments is called an unconformity. Locations that are near the coast are commonly underlain by at least one unconformity. The processes of erosion and deposition can create overconsolidated conditions below unconformities.

The degree of soil consolidation is generally recognized to affect the state of stress. in soils or sediment. The ratio between the horizontal and vertical compressive stress, which is referred to as Ko, increases with the degree of overconsolidation.

This implies that Ko below an unconformity will be greater than Ko above the unconformity. The performance of this invention will improve as Ko increases, and this implies that the performance of this invention practiced below an unconformity will be better than above it. This is particularly important when evaluating locations where this invention is to be practiced. Shallow, normally consolidated sediments may be unsuitable because the state of stress causes hydraulic fractures to be vertical and to propagate upward and reach the ground surface. However, practicing this invention at greater depth, and in particular, at a depth below an unconformity will increase the probability that hydraulic fractures will initially be sub-horizontal.

Recognizing that the performance of this invention conducted in sediments below an unconformity will in many cases be better than above the unconformity is important because many coastal areas where this invention will be practiced will be underlain by sediments with unconformities. This is one aspect where the geologic conditions will affect the performance of this invention.

Effects of Permeability and Pore Pressure.

The grain-size or permeability of the formation is another geologic aspect that will affect performance. In general, the permeability of sediments with a grain size equal to or less than about 100 microns will be too low for the groundwater to be used as a practical resource. Sediments characterized by fine-grained sediments are recognized as confining units and the rate they can transmit water is small.

In aquifers where the water is potable, an ideal location for the practice of this invention is where the injected particles are hydrologically separated from regions that could be used for a water source. The separation can be accomplished by a confining unit of sufficiently low permeability and large thickness so the flow from the area of the invention to aquifer is negligible.

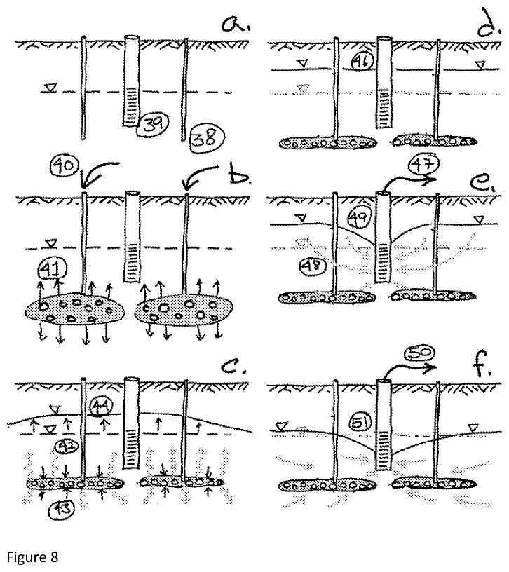

In some formations, water leak off from created fractures may increase the pore pressure and elevation of the water table. This would affect the water flow and may require drainage measures to control the pore pressure in the formation. An example is given in FIG. 8, which illustrates the process of dewatering and reducing the pore pressure after injecting solid particles. FIG. 8a shows a configuration of two casings (38) to be used for injection on either side of a conventional well (39) used for dewatering or pore pressure reduction. The water table is assumed to be equilibrated and no horizontal groundwater flow is assumed in this example, so the water table is level. FIG. 8b shows (40) slurry consisting of solid particles and water, which is injected into the casing and creates a hydraulic fracture while (41) pressure from the injection process displaces the fractures walls, as shown by the black arrows. FIG. 8c shows water that has been injected into the fractures and leaks out of the fracture during injection, and (42) water leakage out of the fracture that also occurs after injection, as shown by the wavy grey arrows. The walls (43) of the fracture close, as shown by the black arrows. Closure of the fracture walls immobilizes the injected carbon-bearing particles and prevents them from migrating upward while (44) leakage of water out of the fracture causes the pore pressure to rise and this can cause the water table to rise. FIG. 8d shows that (46) the water table becomes elevated as a result of one or multiple injections of water. FIG. 8e shows that (47) a pump associated with the conventional well is turned on, causing (48) water that has leaked out of the fracture to flow toward the well, and (49) the pore pressure decreases and the water table falls. FIG. 8f illustrates (50) pumping that continues as needed to decrease the pore pressure and lower the water table sufficiently close to the initial conditions (51). The average pumping rate depicted by (47) in FIG. 8e and (50) in FIG. 8f is matched to the rate of injected water to maintain a water balance.

In this discloser, the term “drainage measures” has the same meaning as the term “drainage installations” and includes a trench, drainage pipe, tile drain, and other installations and equipment that collect groundwater and known to the person of ordinary skill in the art. These terms are used interchangeably.

Water pumped out to reduce pore pressure and lower the water table is tested to evaluate composition and assess water quality effects of the process. Balancing the injection rate with pumping rate at the dewatering wells ensures that no water leaves the vicinity of the injected slurry, assuming there is no horizontal flow of groundwater. If there is ambient horizontal flow of groundwater, then the pumping rate may be greater than the total injection rate to ensure that no injected water leaves the vicinity.

The pore pressure can be reduced and the height of the water table lowered by subsurface drains, drainage tiles, or by using open trenches or ditches, or other methods known to those of ordinary skill in the art.

Groundwater Chemistry.

Groundwater chemistry plays an important role in how groundwater can be used. In many locations near the coast the groundwater contains high concentrations of dissolved ions, similar to seawater. The Maximum Contaminant Limit (MCL) for total dissolved solids is 500 mg/L, and groundwater in many locations near the coast exceeds this concentration and is therefore considered too saline to be used for drinking water. Areas where the salinity of the groundwater is too great to be considered for beneficial use are particularly well suited to this invention.

Biomass in the subsurface is known to be used by microorganisms that consume oxygen leading to anoxic conditions that favor certain chemical reactions. Nitrate is known to degrade under anoxic conditions, for example. Nitrate is a common groundwater contaminant and there is a need to degrade nitrate in-situ in order to reduce the concentration of this contaminant. This invention includes injecting biomass to create anoxic, or anaerobic, or reducing conditions that are used to promote chemical reactions that reduce the concentration of nitrate and other groundwater contaminants. This invention creates a reactive barrier to the migration of groundwater contaminants that are degraded under reducing conditions.

Organic chemicals dissolved in groundwater are known to sorb onto organic compounds preferentially. Biomass is an organic compound and organic chemicals dissolved in groundwater will sorb preferentially and be immobilized when in contact with biomass. This invention creates reactive barriers to the migration of organic compounds that are sorbed onto biomass.

The detailed forgoing description has been presented for purposes of illustration and description. It is not intended to be exhaustive or to limit this disclosure to the precise form disclosed. In light of the above teaching, it will be apparent to those skilled in the art that many modifications, re-arrangements, substitutions, and variations can be made without departing from the spirit and scope of the disclosure. It is intended that the scope of the disclosure be defined by the following claims and their equivalents in which all terms are meant in their broadest reasonable sense unless otherwise indicated.

1. A method of reducing a concentration of carbon dioxide in the atmosphere by placing a solid material containing carbon in the subsurface to reduce a rate of chemical reactions that causes the solid material to degrade to carbon dioxide, the method comprising:
preparing the solid material containing carbon in the form of particles less than about 1 cm in size,
mixing the particles with a liquid to form a slurry,
placing the particles in the subsurface by at least one injection of the slurry into at least one boring extending into a subterranean geologic formation,
injecting the particles into at least one lens in the geologic formation, where they become essentially immobilized.

2. A method according to claim 1 wherein a source of the solid material containing carbon is a biomass.

3. A method according to claim 1 wherein a source of the solid material containing carbon is wood particles created by using a wood chipping equipment.

4. A method according to claim 1 wherein the solid material is a sustainable biomass.

5. A method according to claim 1 wherein the solid material is plastic that is broken into particles, and the plastic could be of different compositions of plastic materials that are mixed together.

6. A method according to claim 5 wherein the plastic material is recovered from waterbodies.

7. A method according to claim 1 wherein the solid material is plants derived from water, wherein the plants are considered a nuisance species.

8. A method according to claim 1 further comprising injecting carbon-bearing particles in water-saturated conditions at a sufficient depth to limit the migration of oxygen and create conditions that limit the rate of biodegradation.

9. A method according to claim 1 further comprising dewatering the geologic formation in the vicinity of the lens of the injected solid carbon-bearing particles by drilling at least one dewatering well and using at least one pump in the well to remove water.

10. A method according to claim 1 further comprising dewatering the geologic formation in the vicinity of the lens of injected solid carbon-bearing particles by creating a drainage installation.

11. A method of controlling orientation of at least one injected lens containing solid carbon-bearing particles, the method comprising:
injecting a slurry of solid particles and a liquid into at least one boring extending into a subterranean geologic formation,
creating at least one lens that increases horizontal compressive stress in the lens vicinity.

12. A method according to claim 11 wherein the slurry is injected at least once.

13. A method according to claim 12 further comprising using at least one lens to increase the horizontal compressive stress and using at least one lens of a different orientation to increase intermediate principal horizontal stress thereby causing horizontal compressive stresses to exceed vertical compressive stress.

14. A method according to claim 12 further comprising using a sequence of injections that restrict upward growth of at least one lens consisting of the injected solid particles.

15. A method according to claim 12 further comprising creating at least one lens that causes the orientation of the next lens to flatten from about vertical to inclined.

16. A method according to claim 14 further comprising creating at least one lens that causes orientation of the subsequent lens to flatten to between horizontal and inclined.

17. A method according to claim 14 further comprising creating at least one lens that causes orientation of the subsequent lens to flatten to about horizontal and create ground displacements that are predominantly vertical.

18. A method according to claim 12 further comprising lenses that are sufficiently small compared to a distance between the lens and the ground surface.

19. A method according to claim 12 wherein subsurface locations, where the horizontal compressive stress is naturally greater than the vertical compressive stress, are identified and selected to use for injection.

20. A method according to claim 12 further comprising injecting below a geologic unconformity where the ratio of horizontal to vertical compressive stress is likely to be larger than elsewhere.

21. A method of controlling injection parameters using data from at least one deformation sensor to favorably affect displacements caused by injection, the method comprising:
using displacement measurements,
processing the data with an inverse modeling method to optimize an injection process and determine the preferred injection parameters.

22. A method according to claim 21 wherein the inverse modeling method is a machine learning method.

23. A method according to claim 21 wherein the displacement measurements are made at a ground surface by at least one surface sensor.

24. A method according to claim 21 wherein the displacement measurements are made in a subsurface by at least one subsurface sensor.

25. A method according to claim 21 further comprising using an artificial neural network to correlate tilt and displacement measurements made at the ground surface with subsurface deformation measurements.

26. A method according to claim 21 further comprising using an artificial neural network to correlate upward displacement measurements made at the ground surface with the injection parameters.
